(19) United States
(12) Patent Application Publication
(10) Pub. No.: US 2014/0021092 A1
(43) Pub. Date: Jan. 23, 2014

(54) PORTABLE ELECTRONIC DEVICE PROTECTOR

(71) Applicant: Cyber Acoustics, LLC, Vancouver, WA (US)

(72) Inventors: Stephen Murphy, Vancouver, WA (US); Kwong Chi Kei, Hong Kong (CN); Lui Suen Yuen, Hong Kong (CN)

(21) Appl. No.: 14/019,358

(22) Filed: Sep. 5, 2013

Related U.S. Application Data
(62) Division of application No. 13/012,720, filed on Jan. 24, 2011.
Application No. 13/012,720 is a continuation-in-part of application No. 12/860,808, filed on Aug. 20, 2010, now Pat. No. 8,281,924.

(51) Int. Cl. G06F 1/16

(52) U.S. Cl. CPC G06F 1/1633
USPC 206/736

(57) ABSTRACT

A protector for portable electronic devices is disclosed, including a portfolio-style protective cover.

This is a divisional of Ser. No. 13/012,720 filed Jan. 24, 2011, which is a continuation-in-part of Ser. No. 12/860,808 filed Aug. 20, 2010, now U.S. Pat. No. 8,281,924, the priority of both of which is claimed pursuant to 35 USC 120.

### BACKGROUND OF THE INVENTION

The development of devices incorporating electronic devices has been explosive over the past decade, resulting in many new genres of battery-powered products such as so-called “smart phones,” electronic readers, and, more recently, the Apple iPad®. All such devices are relatively lightweight and portable, owing to the miniaturization of electronic components and circuitry. One shortcoming of such small scale is that the circuitry is relatively fragile and so subject to damage by, for example, impact with a hard surface caused by dropping and/or exposure to moisture. There is therefore a need in the art for protection of such devices from such damage. This need is met by the present invention.

### BRIEF SUMMARY OF THE INVENTION

According to the present invention, there is provided a protector for portable electronic devices that has a number of unique and useful features that protect such devices from damage and provide support for operating such devices from a desktop or similar flat surface.

### BRIEF DESCRIPTION OF THE SEVERAL VIEWS OF THE DRAWINGS

FIG. 1 is a top perspective view of an exemplary cover of the invention opened to receive an electronic device P such as an Apple iPad®.

FIG. 2 is a sectional taken through the plane 2-2 of FIG. 1.

FIG. 3 is a top perspective view of the outside of the cover shown in FIG. 1.

FIG. 4 is a top perspective view of the cover of FIG. 1 with the electronic device P inserted into the cover and the top of the cover partially open.

FIG. 5 is a top perspective view of the cover of FIG. 1 closed and secured over the electronic device.

FIG. 6 is a top perspective view of the cover of FIG. 1 with the electronic device P inserted into the cover and the top of the cover folded back and secured to the bottom of the cover.

FIG. 7 is a bottom perspective view of the arrangement shown in FIG. 6 illustrating the utility of a hand strap secured to the inside of the top of the cover.

FIG. 8 is a top perspective view of the cover of FIG. 1 with the electronic device P inserted into the cover and the top folded back on itself to tuck into a flap on the outside of the bottom of the cover, so as to create a stand for the electronic device P.

FIG. 9 is a top perspective view of another embodiment of the invention.

FIG. 10 is a perspective view of another embodiment of the invention shown attached to the rear of electronic device P (shown in phantom).

FIG. 11 is a top perspective view of another embodiment of the invention affixed to a portfolio.

### DETAILED DESCRIPTION OF PREFERRED EMBODIMENTS

Referring to the drawings, wherein the same numerals generally refer to the same elements, there is shown a cover 1 designed to accept an electronic device P, the cover comprising a foldable portfolio 10 having a top 10a, a bottom 10b, and a spine 10c. The top 10a and bottom 10b preferably comprise a three-ply lamination of a soft layer 11 such as felt on the inside of the portfolio that is in contact with the electronic device P, a durable outside layer 12 such as leather, and a stiff middle layer 13 to provide structural support to the top and bottom of the cover. Spine 10c preferably comprises only two plies 11 and 12 so as to maintain flexibility on opening and closing. Portfolio 10 is preferably provided with longitudinal creases 14, 15 and 16 to further facilitate flexing, with crease 16 being created by a discontinuity in middle layer 13.

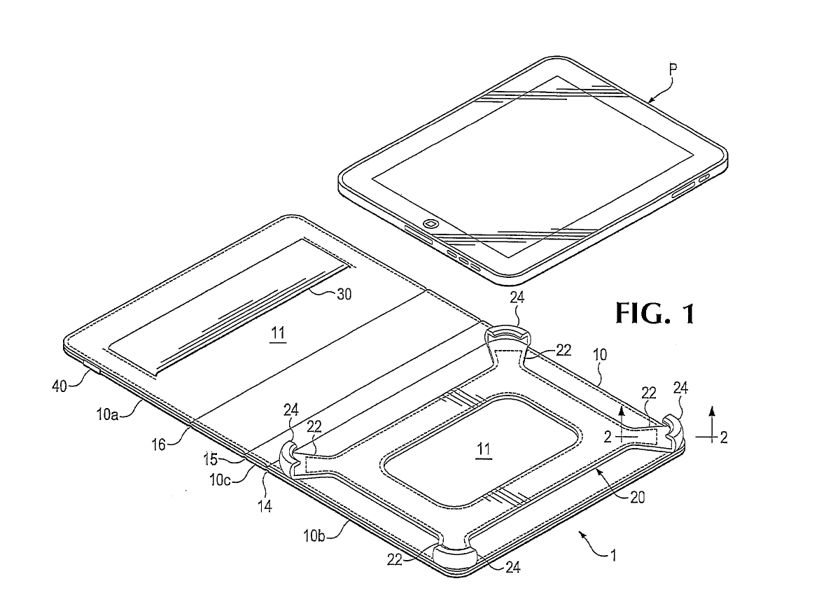

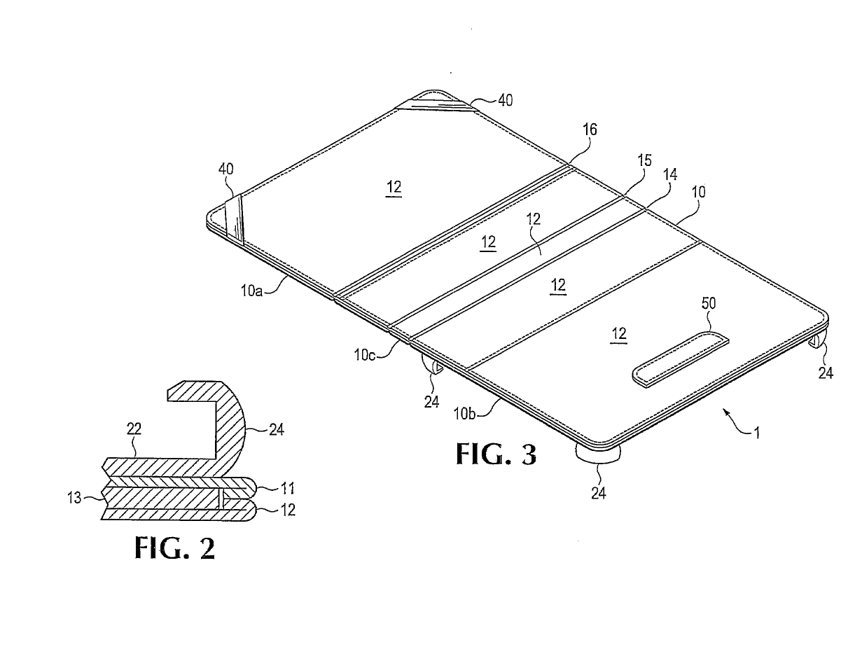

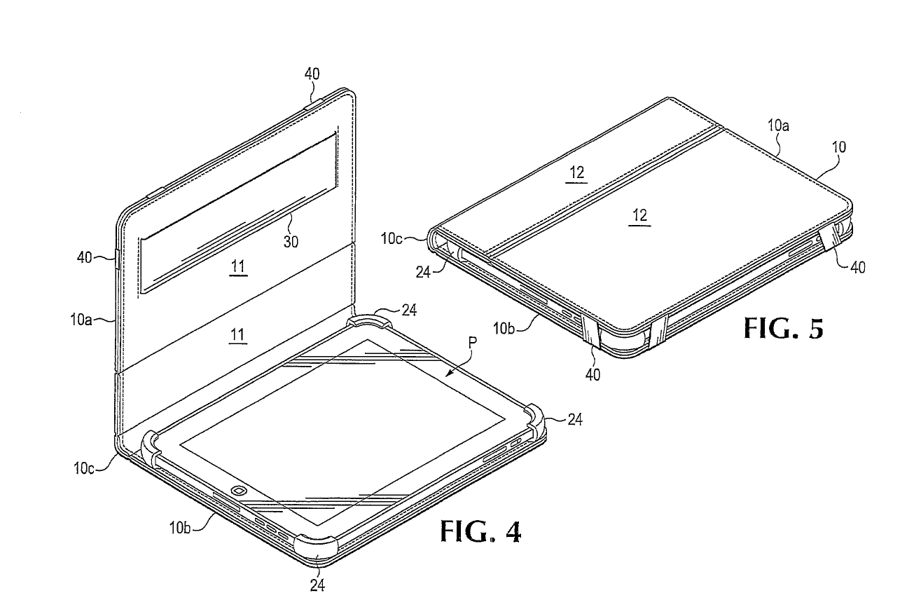

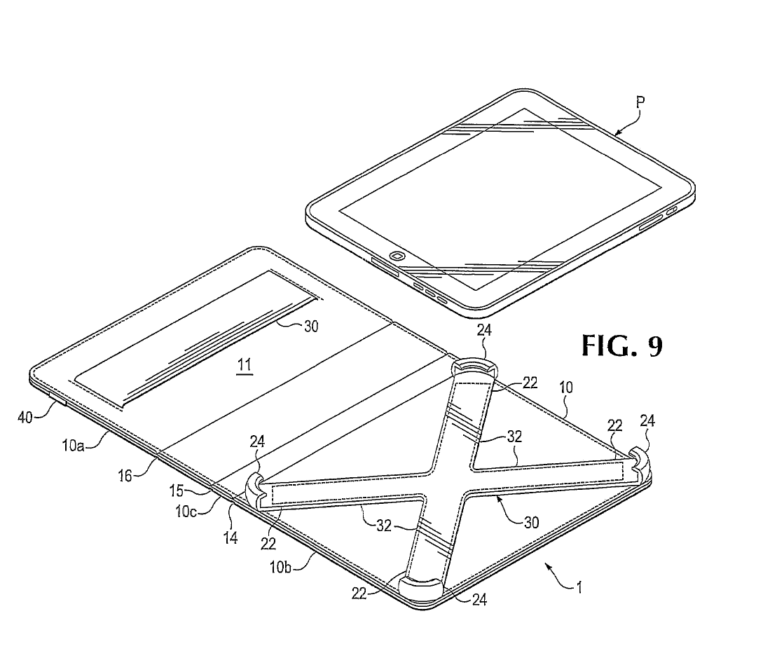

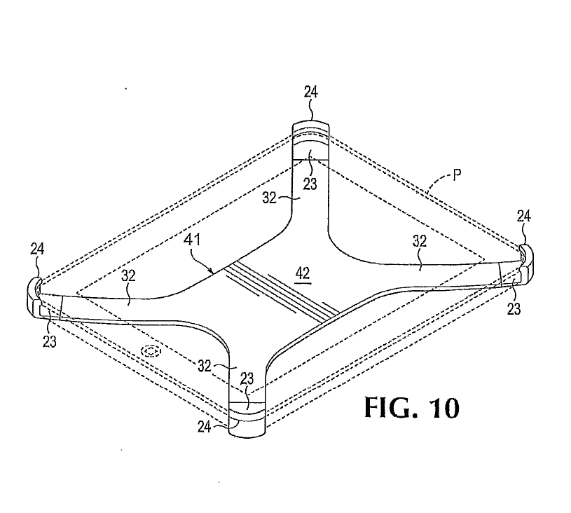

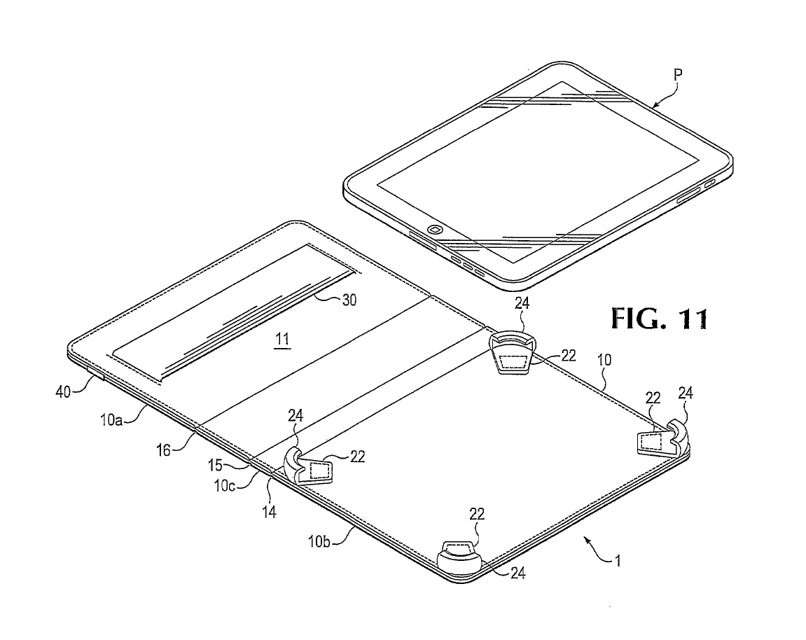

A prominent feature of cover 1 is a four-legged frame that may be in a variety of configurations such as in an O-shape 20 as seen in FIG. 1, an X-shape 30 as seen in FIG. 9, a webbed X-shape 40 as seen in FIG. 10 or as four discrete legs 22 as seen in FIG. 11. With respect to the frames 20, 30 and 40 it should be understood that he same may be used free standing alone independently of any cover or portfolio, or may be incorporated into a cover or portfolio by securing the same to, for example, a bottom 10b, as shown in FIGS. 1 and 9. As to the frame embodiment shown in FIG. 11, the same requires legs 22 to be affixed to a substantially planar and rectangular base such as bottom 10b.

Frame 20 is provided with four legs 22 integral with frame 20 extending radially outwardly and oriented in an X-shaped configuration relative to each other. Legs 22 terminate in four resilient lugs 24 with two pairs of lugs diametrically opposed to each other, the lugs being in an arcuate shape so as to capture the four corners of electronic device P. A preferred material for lugs 24 is silicone rubber. When frame 20, 30 or 40 is secured to a cover such as shown in FIG. 1, lugs 24 hold device P securely in place against bottom 10b. Lugs 24 also serve to absorb shock in the event the electronic device P is struck or dropped onto a hard surface, whether frame 20, 30 or 40 is incorporated into a portfolio or not.

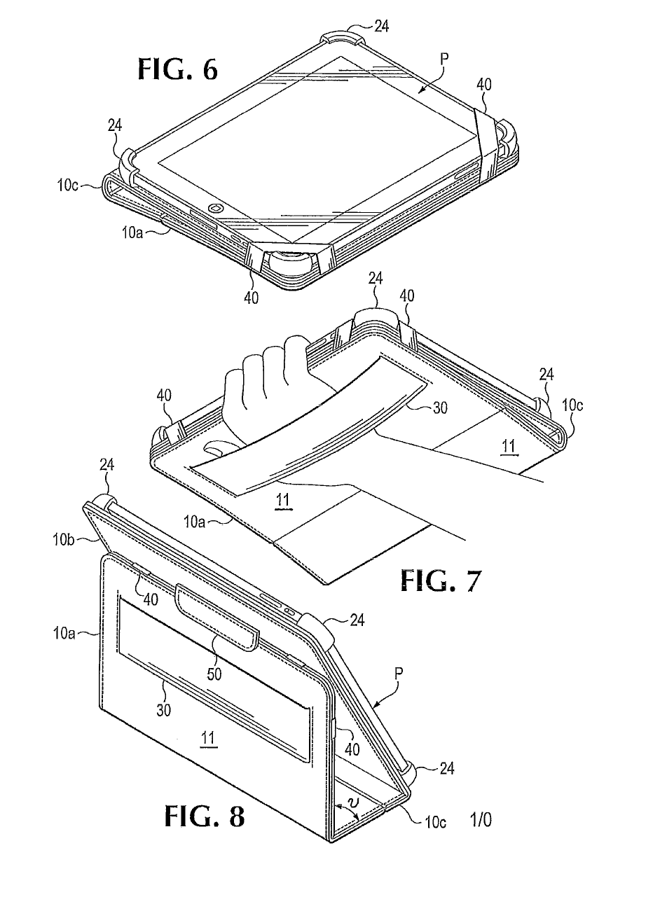

Top 10a is preferably provided at its corners with reversible elastic straps 40 that may be secured to bottom 10b at corresponding corners to secure cover 1 in a closed or open position, best seen in FIGS. 5 and 6, respectively. Preferably such reversible straps 40 are attached to bottom 10b by sewing their ends between layers 11 and 12. Top 10a is further provided with an elastic handle strap 30 on its inside surface 11, which may be deployed by the user to maintain a secure grip on the cover and device P so as to decrease the likelihood of dropping the same.

Finally, bottom 10b is preferably provided with a flap 50 designed to capture the outside edge of top 10a when the same is folded back on itself along crease 16 at an angle 0 of about 90° so as to create an easel or stand for the entire arrangement, best seen in FIG. 8.

Thus, the protector of the invention may be secured to any of a wide variety of portable, generally rectangular electronic devices, including, without limitation, “smart phones,” e-readers, e-planners, e-calendars, and e-tablets such as the Apple iPad® to protect the device while maintaining easy access to the device by the user.

The terms and expressions which have been employed in this specification are used therein as terms of description and not of limitation, and there is no intention in the use of such terms and expressions to exclude equivalents of the features shown and described or portions thereof, it being recognized that the scope of the invention is defined and limited only by the claims which follow.

What is claimed is:

1. A cover for an electronic device to protect the electronic device from damage, the cover comprising:
a portfolio having a top portion and a bottom portion, the bottom portion defining four corners; and
a frame coupled to the bottom portion, the frame including four legs and four resilient lugs, each of said resilient lugs coupled to an end of a different one of said four legs, the four legs generally defining an X-shape
wherein each of the four lugs is substantially aligned with one of the four corners of said bottom portion, and wherein said top portion is foldable relative to said bottom portion to access an electronic device engaged by said frame.

2. The cover of claim 1 wherein said top portion defines four corners and said four corners of said top portion substantially align with the four corners of the bottom portion when the top portion is in a closed position.

3. The cover of claim 1 wherein said frame includes a generally rectangular O-shaped portion and wherein said four legs extend from said O-shaped portion.

4. The cover of claim 1 wherein said top portion of said portfolio is structured to fold to support the portfolio in a standing position.

5. The cover of claim 4 wherein said bottom portion includes a flap and said top portion is configured to fold relative to said flap and engage said flap to support the portfolio in the standing position.

6. The cover of claim 4 wherein said top of said portfolio comprises a three-ply lamination, said three-ply lamination including a middle support layer defining a discontinuity and said top portion is foldable along said discontinuity.

7. The cover of claim 1 wherein said bottom portion of said portfolio includes an engagement member structured so as to engage said top portion and to retain said portfolio in a standing position.

8. A cover for an electronic device to protect the electronic device from damage, the cover comprising:
a frame including four legs and a generally rectangular O-shaped portion, each of the four legs having a distal end and a proximal end, the proximal end of each of the four legs coupled to said O-shaped frame, whereby the four legs generally define an X-shape, the frame includes four resilient lugs, each of the resilient lugs coupled to the distal end of a different one of the four legs, each of the resilient lugs structured to capture a corner of the electronic device; and
a portfolio having a first portion and a second portion, each of the first and second portions defining a substantially rectangular shape having four corners wherein said first portion is movable from a closed position to at least one open position and
the four corners of said first and second portions substantially align with said four resilient lugs when the portfolio is in a closed position.

9. The cover of claim 8 wherein said first portion comprise a lamination including a structural middle layer and said structural middle layer defines a discontinuity such that said first portion is foldable along said discontinuity.

10. The cover of claim 9 wherein said discontinuity of said first portion defines an integral hinge.

11. The cover of claim 10 wherein said integral hinge permits a section of the first portion to be partially opened to an angle of about 90° relative to a remaining section of the first portion to engage the second portion in a standing position.

12. The cover of claim 8 wherein the second portion is structured to retain the first portion in an open standing position.

13. A cover for an electronic device to protect the electronic device from damage, the cover comprising:
a portfolio having a first portion and a second portion, the first portion defining a substantially rectangular shape having four corners, the first portion foldable relative to the second portion to define a closed position and at least one open position; and
a frame including four resilient lugs, the frame member coupled to the second portion such that each of the four lugs substantially aligns with one of the four corners of the first portion of the portfolio when the cover is in a closed position.

14. The cover of claim 13 wherein said frame generally defines an X-shape having four legs extending from a generally rectangular O-shaped body portion and each of said four legs extends from said O-shaped body portion.

15. The cover of claim 14 wherein each of said resilient lugs is disposed at a distal end of a different one of said four legs.

16. The cover of claim 13 wherein said first portion is substantially the same size and shape as said second portion.
